(19) United States
(12) Patent Application Publication
(10) Pub. No.: US 2007/0215586 A1
(43) Pub. Date: Sep. 20, 2007

(54) Nickel alloy welding wire

(76) Inventors: Clifford Graillat, Westbrook, CT (US); Steven Ivory, Manchester, CT (US); Michael Minor, Arlington, TX (US)

Correspondence Address: BACHMAN & LAPOINTE, P.C. (P&W), 900 CHAPEL STREET, SUITE 1201, NEW HAVEN, CT, 06510-2802, US

(21) Appl. No.: 11/377,947

(22) Filed: Mar. 16, 2006

(51) Int. Cl. B23K 35/30

(52) U.S. Cl. 219/137 WM; 219/146.22

(57) ABSTRACT

In accordance with a first embodiment of the present invention, a nickel alloy welding wire is made from a material comprising from about 4.75 to 5.25 wt % chromium, from about 5.5 to 5.8 wt % aluminum, from about 5.6 to 6.2 wt % tungsten, from about 8.0 to 8.3 wt % tantalum, from about 1.7 to 2.1 wt % molybdenum, from about 9.5 to 10.5 wt % cobalt, from about 2.8 to 3.2 wt % rhenium, from about 0.07 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel. In a second embodiment of the present invention, a nickel alloy welding wire is made from a material comprising from about 4.75 to 5.25 wt % chromium, from about 5.5 to 5.8 wt % aluminum, from about 5.6 to 6.2 wt % tungsten, from about 8.0 to 9.0 wt % tantalum, from about 1.7 to 2.1 wt % molybdenum, from about 9.5 to 10.5 wt % cobalt, from about 2.8 to 3.2 wt % rhenium, from about 0.18 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel.

### BACKGROUND OF THE INVENTION

(1) Field of the Invention

The present invention relates to a nickel alloy welding wire utilized for the weld repair of nickel-based superalloy components, particularly turbine blades and to a method for repairing components using the nickel alloy welding wire.

(2) Prior Art

Nickel based superalloys have found use in a variety of high technology applications. Single crystal, directionally solidified and equiaxed nickel-based alloys that exhibit strength and oxidation resistance at high temperature are particularly useful in forming engine components. Since articles composed of nickel-based superalloys are expensive or difficult to replace, there is a need for methods of repairing such articles. One such repair method is illustrated in U.S. Pat. No. 5,783,318.

Despite prior efforts in the area of repair of nickel-based superalloys, there remains a need for new methods of repairing nickel-based superalloy substrates. There is a corresponding need for a nickel based alloy that is suitable for coating or repair of substrates.

### SUMMARY OF THE INVENTION

In accordance with the present invention, the nickel alloy welding wire in a first embodiment may be made from a material comprising from about 4.75 to 5.25 wt % chromium, from about 5.5 to 5.8 wt % aluminum, from about 5.6 to 6.2 wt % tungsten, from about 8.0 to 8.3 wt % tantalum, from about 1.7 to 2.1 wt % molybdenum, from about 9.5 to 10.5 wt % cobalt, from about 2.8 to 3.2 wt % rhenium, from about 0.07 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel. The material may further comprise up to about 0.12 wt % manganese, up to about 0.12 wt % silicon, up to about 0.015 wt % phosphorous, up to about 0.015 wt % sulfur, up to about 0.20 wt % iron, and up to about 0.10 wt % copper.

In accordance with the present invention, the nickel alloy welding wire in a second embodiment may be made from a material comprising from about 4.75 to 5.25 wt % chromium, from about 5.5 to 5.8 wt % aluminum, from about 5.6 to 6.2 wt % tungsten, from about 8.0 to 9.0 wt % tantalum, from about 1.7 to 2.1 wt % molybdenum, from about 9.5 to 10.5 wt % cobalt, from about 2.8 to 3.2 wt % rhenium, from about 0.18 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel. The material may further comprise up to about 0.12 wt % manganese, up to about 0.12 wt % silicon, up to about 0.015 wt % phosphorous, up to about 0.015 wt % sulfur, up to about 0.20 wt % iron, and up to about 0.10 wt % copper.

A method for repairing a crack in a workpiece, such as a turbine engine component is provided. The method broadly comprises the steps of providing a workpiece having a crack, heating the workpiece to a temperature in the range of from about 1625 to 1675 degrees Fahrenheit for a time in the range of from about 2.0 to 3.0 minutes, and repairing the crack by applying a welding wire having one of the aforesaid compositions in accordance with the present invention and maintaining the temperature until the repair material of the welding wire flows into and fills the crack.

Other details of the nickel alloy welding wire of the present invention, as well as other objects and advantages attendant thereto, are set forth in the following detailed description.

### DETAILED DESCRIPTION OF THE PREFERRED EMBODIMENT(S)

As noted above, the present invention is directed to a nickel alloy welding wire which may be used to repair cracks in turbine engine components formed from a nickel-based superalloy. In a first embodiment, the nickel welding wire may be formed from a material having a composition comprising from about 4.75 to 5.25 wt % chromium, from about 5.5 to 5.8 wt % aluminum, from about 5.6 to 6.2 wt % tungsten, from about 8.0 to 8.3 wt % tantalum, from about 1.7 to 2.1 wt % molybdenum, from about 9.5 to 10.5 wt % cobalt, from about 2.8 to 3.2 wt % rhenium, from about 0.07 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel. The material may further comprise up to about 0.12 wt % manganese, up to about 0.12 wt % silicon, up to about 0.015 wt % phosphorous, up to about 0.015 wt % sulfur, up to about 0.20 wt % iron, and up to about 0.10 wt % copper.

In a second embodiment, the nickel alloy welding wire may be formed from a material having a composition comprising from about 4.75 to 5.25 wt % chromium, from about 5.5 to 5.8 wt % aluminum, from about 5.6 to 6.2 wt % tungsten, from about 8.0 to 9.0 wt % tantalum, from about 1.7 to 2.1 wt % molybdenum, from about 9.5 to 10.5 wt % cobalt, from about 2.8 to 3.2 wt % rhenium, from about 0.18 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel. The material may further comprise up to about 0.12 wt % manganese, up to about 0.12 wt % silicon, up to about 0.015 wt % phosphorous, up to about 0.015 wt % sulfur, up to about 0.20 wt % iron, and up to about 0.10 wt % copper.

The welding wire of the present invention may be formed by casting a material having one of the foregoing compositions into any suitable form including, but not limited to, a billet or a rod form. After casting has been completed, the cast material may be subjected to one or more heat treatments to increase its ductility. Thereafter, the material may be formed into a wire by one or more cold rolling and/or extrusion operations. These cold rolling and/or extrusion operations are preferably performed in a suitable protective atmosphere. The extrusion operation is preferably formed at a temperature of about 2000 degrees Fahrenheit. After being formed into a wire state, the welding wire may be subjected to a grind operation which gives the wire its final finish. Additionally, the welding wire may be subjected to a cleaning process for removing drawing compounds, oxides, dirt and oil. The cleaning process should not result in pitting or cause gas absorption by the wire or deposition of substances harmful to welding operations.

The welding wire is preferably in a temper that provides proper feeding of the wire into machine welding equipment. The welding wire may be provided with this temper in any suitable manner known in the art. For example, the welding wire may be processed as set forth in any of U.S. Pat. Nos. 4,323,186; 4,777,710; and 6,586,060, which patents are incorporated by reference herein.

To effect a repair on a cracked turbine engine component, such as a cracked turbine blade airfoil tip, the crack may be cleaned first to remove any debris or unwanted material. Any suitable technique known in the art may be used to repair the crack. After the crack has been cleaned, the cracked turbine engine component may be heated to a temperature in the range of from about 1625 to about 1675 degrees Fahrenheit via induction heating and held at that temperature for a time in the range of from about 2.0 to about 3.0 minutes. Thereafter, the crack may be welded using a welding wire having a composition in accordance with the present invention, while maintaining the temperature in the aforesaid range. This causes the material forming the welding wire to flow into the crack being repaired. The aforesaid crack repair operation may be performed in any suitable atmosphere known in the art. After the crack has been completely filled with the material forming the welding wire, the application of heat is halted and the repair material is allowed to solidify.

If desired, the repaired turbine engine component may then be subjected to a heat treatment for stress relief. This heat treatment may be carried out at a temperature in the range of from about 1950 to about 2000 degrees Fahrenheit for a time period in the range of from about three to five minutes. The stress relief heat treatment may be carried out in any suitable atmosphere known in the art. Any excess repair material at the repair site may be removed using any suitable means known in the art.

The welding wire of the present invention features improved material characteristics over comparable currently used weld filler materials and may be used for high temperature applications. The welding wire may be used for crack repair as well as weld build up. The welding wire may be used to repair cracks in turbine engine components such as turbine blades, vanes, seals, BOAS, and combustor panels.

While the present invention has been described in the context of repairing cracks in turbine engine components, it should be recognized that the welding wire compositions of the present invention may be used to repair cracks in other types of workpieces.

It is apparent that there has been provided in accordance with the present invention a nickel alloy welding wire which fully satisfies the objects, means, and advantages set forth hereinbefore. While the present invention has been described in the context of specific embodiments thereof, unforeseeable alternatives, modifications and variations may become apparent to those skilled in the art having read the foregoing description. Accordingly, it is intended to embrace those unforeseeable alternatives, modifications, and variations as fall within the broad scope of the appended claims.

What is claimed is:

1. A nickel alloy wire to be used in effecting repairs to nickel based superalloy components, said nickel based alloy being formed from a material comprising from about 4.75 to 5.25 wt % chromium, from about 5.5 to 5.8 wt % aluminum, from about 5.6 to 6.2 wt % tungsten, from about 8.0 to 8.3 wt % tantalum, from about 1.7 to 2.1 wt % molybdenum, from about 9.5 to 10.5 wt % cobalt, from about 2.8 to 3.2 wt % rhenium, from about 0.07 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel.

2. The nickel alloy wire of claim 1, wherein said material further comprises up to about 0.12 wt % manganese, up to about 0.12 wt % silicon, up to about 0.015 wt % phosphorous, up to about 0.015 wt % sulfur, up to about 0.20 wt % iron, and up to about 0.10 wt % copper.

3. The nickel alloy wire of claim 1, wherein said wire has a temper which provides proper feeding of the wire into machine welding equipment.

4. A nickel alloy wire to be used in effecting repairs to nickel based superalloy components, said nickel based alloy being formed from a material comprising from about 4.75 to 5.25 wt % chromium, from about 5.5 to 5.8 wt % aluminum, from about 5.6 to 6.2 wt % tungsten, from about 8.0 to 9.0 wt % tantalum, from about 1.7 to 2.1 wt % molybdenum, from about 9.5 to 10.5 wt % cobalt, from about 2.8 to 3.2 wt % rhenium, from about 0.18 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel.

5. The nickel alloy wire of claim 4, wherein said material further comprises up to about 0.12 wt % manganese, up to about 0.12 wt % silicon, up to about 0.015 wt % phosphorous, up to about 0.015 wt % sulfur, up to about 0.20 wt % iron, and up to about 0.10 wt % copper.

6. The nickel alloy wire of claim 4, wherein said wire has a temper that provides proper feeding of the wire into machine welding equipment.

7. A method for repairing a crack in a workpiece comprising the steps of:
providing a workpiece having a crack;
heating said workpiece to a temperature in the range of from about 1625 to 1675 degrees Fahrenheit for a time in the range of from about 2.0 to 3.0 minutes; and
repairing said crack by applying a welding wire formed from a nickel based alloy having a composition comprising from about 4.75 to 5.25 wt % chromium, from about 5.5 to 5.8 wt % aluminum, from about 5.6 to 6.2 wt % tungsten, from about 8.0 to 8.3 wt % tantalum, from about 1.7 to 2.1 wt % molybdenum, from about 9.5 to 10.5 wt % cobalt, from about 2.8 to 3.2 wt % rhenium, from about 0.07 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel to said crack and maintaining said temperature until said material flows into and fills said crack.

8. The method according to claim 7, wherein said heating step comprises heating said workpiece with an induction heater.

9. The method according to claim 7, further comprising subjecting said workpiece to a stress relief heat treatment.

10. The method according to claim 9, wherein said subjecting step comprises heating said workpiece to a temperature in the range of from about 1950 to 2000 degrees Fahrenheit for a time period in the range of from about three to five minutes.

11. The method according to claim 7, wherein said workpiece providing step comprises providing a turbine engine component having a crack to be repaired.

12. A method for repairing a crack in a workpiece comprising the steps of:
providing a workpiece having a crack;
heating said workpiece to a temperature in the range of from about 1625 to 1675 degrees Fahrenheit for a time in the range of from about 2.0 to 3.0 minutes; and
repairing said crack by applying a welding wire formed from a nickel based alloy having a composition comprising from about 4.75 to 5.25 wt % chromium, from about 5.5 to 5.8 wt % aluminum, from about 5.6 to 6.2 wt % tungsten, from about 8.0 to 9.0 wt % tantalum, from about 1.7 to 2.1 wt % molybdenum, from about 9.5 to 10.5 wt % cobalt, from about 2.8 to 3.2 wt % rhenium, from about 0.18 to 0.30 wt % carbon, from about 0.02 to 0.04 wt % boron, from about 0.08 to 0.12 wt % zirconium, from about 0.08 to 0.12 wt % yttrium, from about 1.0 to 1.5 wt % hafnium, and the balance nickel to said crack and maintaining said temperature until said material flows into and fills said crack.

13. The method according to claim 12, wherein said heating step comprises heating said workpiece with an induction heater.

14. The method according to claim 12, further comprising subjecting said workpiece to a stress relief heat treatment.

15. The method according to claim 14, wherein said subjecting step comprises heating said workpiece to a temperature in the range of from about 1950 to 2000 degrees Fahrenheit for a time period in the range of from about three to five minutes.

16. The method according to claim 12, wherein said workpiece providing step comprises providing a turbine engine component having a crack to be repaired.
